(19) United States
(12) Patent Application Publication
(10) Pub. No.: US 2025/0383202 A1
(43) Pub. Date: Dec. 18, 2025

(54) IMPROVED SYSTEM, METHOD AND COMPUTER PROGRAM PRODUCT FOR NORTH-FINDING

(71) Applicant: ISRAEL AEROSPACE INDUSTRIES LTD., Lod (IL)

(72) Inventors: Avraham TURGEMAN, Shoham (IL); Beniamin NAOR, Rishon Letzion (IL)

(21) Appl. No.: 18/880,164

(22) PCT Filed: Jun. 21, 2023
(86) PCT No.: PCT/IL2023/050639

§ 371 Date: Dec. 30, 2024

(30) Foreign Application Priority Data
Jun. 29, 2022 (IL) 294417

(51) Int. Cl. G01C 19/38; G01C 21/16; G01C 21/18

(52) U.S. Cl. CPC G01C 19/38; G01C 21/166; G01C 21/18; G01C 21/188

(57) ABSTRACT

A system for finding a target direction, the system comprising a gyroscope and/or an accelerometer perpendicular to the gyroscope and/or a rotating stage on which the gyroscope and accelerometer are mounted, and/or a hardware processor configured for computing a first azimuthal orientation which points to a horizontal direction, based on readings taken when the gyroscope and accelerometer are in a first azimuthal position; and/or an estimation of a required direction based on: at least one gyroscope reading and at least one accelerometer reading in the first azimuthal position and/or at least one gyroscope reading and at least one accelerometer reading in a second, opposite azimuthal position 180 degrees away from the first position.

### FIELD OF THIS DISCLOSURE

The present invention relates generally to gyroscopes, and more particularly to north-finding.

### BACKGROUND FOR THIS DISCLOSURE

GPS technology is useful for navigation, including north-finding. However, GPS availability is not guaranteed, and even if generally available, can easily be blocked or disrupted. Therefore, stand-alone north-finding, which is not reliant on GPS, has significant utility.

MS1000, a MEMS accelerometer for North Finding, is described here: colibrys.com/wp-content/uploads/2017/09/an-north-finding.pdf.

The Terra 1000 NF is a state of the art North Finding System, described here: cielo-inertial.com/products/nf/terra-1000-nf/.

The HG5700 is a gyrocompass-grade Inertial Measurement Unit (IMU)/Inertial Navigation System (INS) whose INS capabilities include north finding, as described here: aerospace.honeywell.com/us/en/learn/products/sensors/hg5700-inertial-measurement-unit.

Conventional gyroscopes include static, costly, accurate gyroscopes (e.g., ring laser aka RLG gyroscopes), as well as less costly, less accurate gyroscopes such as FOG gyroscopes, which can be less costly by an order of magnitude. FOG gyroscope systems include closed-loop gyroscopes, which lower errors but are more costly, as well as open-loop FOG gyroscopes, which are less typically less costly, but may fail to provide a level of accuracy which suits a given use-case.

This publication colibrys.com/wp-content/uploads/2017/09/an-north-finding.pdf describes a single 2-axis gyroscope used to find north.

FOG gyroscopes are described here:

en.wikipedia.org/wiki/Fibre-optic_gyroscope.

North-finding, which uses carouseling to achieve accuracy, is described here: kth-cover_v4_part1.pdf (diva-portal.org).

The disclosures of all publications and patent documents mentioned in the specification, and of the publications and patent documents cited therein directly or indirectly, are hereby incorporated by reference, other than subject matter disclaimers or disavowals. If the incorporated material is inconsistent with the express disclosure herein, the interpretation is that the express disclosure herein describes certain embodiments, whereas the incorporated material describes other embodiments. Definition/s within the incorporated material may be regarded as one possible definition for the term/s in question.

### SUMMARY OF CERTAIN EMBODIMENTS

North finding is widely useful e.g., for tactical navigation and target orientation localization, both in stationary/fixed/static observation systems and in portable, e.g., hand-held north-finding devices.

There are several known methods for north finding, which are normally subject to trade-offs between cost, time, noise sensitivity, and size. Certain embodiments seek to beat the conventional trade-off between cost, time, noise sensitivity, and size, by providing a north-finding method which is both more time effective and features lower noise sensitivity, relative to other methods.

Certain embodiments seek to provide a north-finding system and process that is simultaneously more accurate and/or more noise insensitive and/or requires less operation time and/or requires less accurate hence less costly hardware, relative to certain conventional north-finding systems.

Certain embodiments seek to provide a process for finding north by using a smart selection of measurement points.

Certain embodiments seek to provide a process for finding north whose accuracy is about 1-2 mRad and/or which requires only a few (less than 10, or less than 7, or about 5) minutes and/or which makes do with a FOG gyroscope or other gyroscope of a similar level of cost.

Certain embodiments seek to provide an improved, faster gyroscope-based process for finding north which eliminates self-bias of the gyroscope by suitable positioning thereof, typically in a first position, and then in a second azimuthal position 180 degrees away, and/or reduces north-finding error by providing plural measurements which may be combined e.g. averaged, thereby to achieve high accuracy, even when using a single, relatively low-cost (and thus relatively inaccurate) gyroscope.

Certain embodiments seek to provide a north-finding method, which provides fast and accurate results and/or has low sensitivity to noise, and/or is suitable for field applications (e.g. outdoor, noisy environment with low signal to noise ratio (e.g. a vehicle with its motor on, in which case a gyro mounted on the vehicle measures not only the earth's rotation (signal) but also the vehicle's movements and vibrations (noise), uneven, rough, or tilted terrain) and/or for vehicles which require accurate north finding in a short time and in a noisy environment.

Certain embodiments seek to provide a north-finding method, which can achieve high accuracy such as a few (e.g., 2 or 4 or 9) mRad, within a reasonable time-period. It is appreciated that use-cases differ in the level of accuracy they require, depending, e.g., on whether the north-finding is being employed for navigation purposes or for targeting, or (for radar) depending on accuracy of the radar's detection angle.

Certain embodiments of the present invention seek to provide circuitry typically comprising at least one processor in communication with at least one memory, with instructions stored in such memory executed by the processor to provide functionalities which are described herein in detail. Any functionality described herein may be firmware-implemented or processor-implemented, as appropriate.

It is appreciated that any reference herein to, or recitation of, an operation being performed, e.g. if the operation is performed at least partly in software, is intended to include both an embodiment where the operation is performed in its entirety by a server A, and also to include any type of “outsourcing” or “cloud” embodiments in which the operation, or portions thereof, is or are performed by a remote processor P (or several such), which may be deployed off-shore or “on a cloud”, and an output of the operation is then communicated to, e.g. over a suitable computer network, and used by, server A. Analogously, the remote processor P may not, itself, perform all of the operations, and, instead, the remote processor P itself may receive output/s of portion/s of the operation from yet another processor/s P′, may be deployed off-shore relative to P, or “on a cloud”, and so forth.

The present invention typically includes at least the following embodiments: Embodiment 1. An improved method for finding a target direction, the method comprising computing a first azimuthal position which points to a horizontal direction; and/or moving a gyroscope and/or accelerometer from the first azimuthal position to a second azimuthal position which may be 180 degrees away; and/or obtaining at least one gyroscope reading and/or at least one accelerometer reading e.g. in each of the two positions; and/or using a hardware processor for computing an estimation of a required direction which may be based on the at least one gyroscope reading and/or at least one accelerometer reading in the first azimuthal position and/or on the at least one gyroscope reading and/or at least one accelerometer reading in the second azimuthal position.

It is appreciated that the required direction need not be north. Also, even if the target direction is (say) north, the method herein may be used to find a required direction other than the target direction, say south instead of north, and the target direction (say north) may then be found by adding 180 degrees (say) to the south-direction (say) as identified by the method herein, which yields north. The horizontal direction may, for example, be east.

Embodiment 2. A method according to the preceding embodiment, wherein the at least one gyroscope reading and at least one accelerometer reading in each of the two positions comprises plural gyroscope readings and plural accelerometer readings in each of the two positions, and wherein the computing an estimation of the required direction comprises estimating the required direction plural times, based on each of the plural gyroscope readings and plural accelerometer readings respectively, yielding plural estimations of the required direction; and/or combining the plural estimations of the required direction to yield a single accurate estimation of the required direction.

Embodiment 3. A method according to any of the preceding embodiments, wherein the combining comprises averaging.

Embodiment 4. A method according to any of the preceding embodiments, wherein the gyroscope measures its own angular velocity relative to its own inertial position.

Embodiment 5. A system for finding a target direction, the system comprising:
a gyroscope and/or an accelerometer which may be perpendicular to the gyroscope and/or a rotating stage on which the gyroscope and/or accelerometer are mounted, and/or a hardware processor which may be configured for computing a first azimuthal orientation which points to a horizontal direction, e.g. based on readings taken when the gyroscope and/or accelerometer are in a first azimuthal position; and/or an estimation of a required direction which may be based on: at least one gyroscope reading and/or at least one accelerometer reading in the first azimuthal position and/or at least one gyroscope reading and/or at least one accelerometer reading in a second, opposite azimuthal position which may be 180 degrees away from the first position.

Embodiment 6. A system according to any of the preceding embodiments wherein the horizontal direction comprises east.

Embodiment 7. A system according to any of the preceding embodiments wherein the required direction comprises north.

Embodiment 8. A system according to any of the preceding embodiments wherein the target direction comprises north.

Embodiment 9. A system according to any of the preceding embodiments wherein the required direction equals the target direction.

Embodiment 10. A method according to any of the preceding embodiments wherein the horizontal direction comprises east.

Embodiment 11. A method according to any of the preceding embodiments wherein the required direction comprises north.

Embodiment 12. A method according to any of the preceding embodiments wherein the target direction comprises north.

Embodiment 13. A method according to any of the preceding embodiments wherein the required direction equals the target direction.

Embodiment 14. A method according to any of the preceding embodiments wherein an azimuthal distance between the target and required directions is known and wherein, accordingly, the target direction is computed from the estimation of the required direction.

Embodiment 15. A system according to any of the preceding embodiments and also comprising an output device configured to generate a physical output indication of at least one of the required and target directions, which is perceptible to a human.

Embodiment 16. A system according to any of the preceding embodiments wherein the output device comprises a display screen.

Embodiment 17. A system according to any of the preceding embodiments and also comprising an output device configured to generate an output indication of at least one of the required and target directions which is machine-readable by an external system.

Embodiment 18. A system according to any of the preceding embodiments wherein the output indication is provided to the external system via an API.

Embodiment 19. A system according to any of the preceding embodiments wherein the gyroscope comprises a single gyroscope.

Embodiment 20. A system according to any of the preceding embodiments wherein the gyroscope comprises a FOG gyroscope.

Embodiment 21. A system according to any of the preceding embodiments wherein the FOG gyroscope comprises an open-loop FOG gyroscope.

Embodiment 22. A method according to any of the preceding embodiments wherein the estimation of the required direction is also based on at least one gyroscope reading and at least one accelerometer reading obtained from a gyroscope in a second, opposite azimuthal position 180 degrees away from the first azimuthal position.

Embodiment 23. A method according to any of the preceding embodiments wherein the single gyroscope is rotated between the first and second azimuthal positions to allow the single gyroscope to provide at least one gyroscope reading and at least one accelerometer reading while the gyroscope is in the first azimuthal position, and at least one gyroscope reading and at least one accelerometer reading while the gyroscope is in the second azimuthal position.

Also provided, excluding signals, is a computer program comprising computer program code means for performing any of the methods shown and described herein when the program is run on at least one computer; and a computer program product, comprising a typically non-transitory computer-usable or -readable medium e.g. non-transitory computer-usable or -readable storage medium, typically tangible, having a computer readable program code embodied therein, the computer readable program code adapted to be executed to implement any or all of the methods shown and described herein. The operations in accordance with the teachings herein may be performed by at least one computer specially constructed for the desired purposes, or a general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display e.g., on a computer screen or other computer output device, store, and accept information such as information used by or generated by any of the methods and apparatus shown and described herein; the above processor/s, display and input means including computer programs, in accordance with all or any subset of the embodiments of the present invention. Any or all functionalities of the invention shown and described herein, such as but not limited to operations within flowcharts, may be performed by any one or more of: at least one conventional personal computer processor, workstation or other programmable device or computer or electronic computing device or processor, either general-purpose or specifically constructed, used for processing; a computer display screen and/or printer and/or speaker for displaying; machine-readable memory such as flash drives, optical disks, CDROMs, DVDs, BluRays, magnetic-optical discs or other discs; RAMs, ROMS, EPROMS, EEPROMs, magnetic or optical or other cards, for storing, and a keyboard or mouse for accepting. Modules illustrated and described herein may include any one or combination or plurality of: a server, a data processor, a memory/computer storage, a communication interface (wireless (e.g., BLE) or wired (e.g., USB)), and/or a computer program stored in memory/computer storage.

The term “process” as used above is intended to include any type of computation or manipulation or transformation of data represented as physical, e.g. electronic, phenomena which may occur or reside e.g. within registers and/or memories of at least one computer or processor. Use of nouns in singular form is not intended to be limiting; thus the term processor is intended to include a plurality of processing units which may be distributed or remote, the term server is intended to include plural typically interconnected modules running on plural respective servers, and so forth.

The above devices may communicate via any conventional wired or wireless digital communication means, e.g., via a wired or cellular telephone network or a computer network such as the Internet.

The apparatus of the present invention may include, according to certain embodiments of the invention, machine readable memory containing or otherwise storing a program of instructions which, when executed by the machine, implements all or any subset of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless stated otherwise, terms such as, “processing”, “computing”, “estimating”, “generating”, “selecting”, “ranking”, “grading”, “calculating”, “determining”, “reassessing”, “classifying”, “generating”, “producing”, “stereo-matching”, “registering”, “detecting”, “associating”, “superimposing”, “obtaining”, “providing”, “accessing”, “setting” or the like, refer to the action and/or processes of at least one computer/s or computing system/s, or processor/s or similar electronic computing device/s or circuitry, that manipulate and/or transform data which may be represented as physical, such as electronic, quantities e.g. within the computing system's registers and/or memories, and/or may be provided on-the-fly, into other data which may be similarly represented as physical quantities within the computing system's memories, registers or other such information storage, transmission or display devices, or may be provided to external factors e.g. via a suitable data network. The term “computer” should be broadly construed to cover any kind of electronic device with data processing capabilities, including, by way of non-limiting example, personal computers, servers, embedded cores, computing systems, communication devices, processors (e.g. a digital signal processor (DSP), microcontrollers, field programmable gate array (FPGA), application specific integrated circuit (ASIC), etc.) and other electronic computing devices. Any reference to a computer, controller or processor is intended to include one or more hardware devices e.g., chips, which may be co-located or remote from one another. Any controller or processor may for example comprise at least one CPU, DSP, FPGA or ASIC, suitably configured in accordance with the logic and functionalities described herein.

Any feature or logic or functionality described herein may be implemented by processor/s or controller/s configured as per the described feature or logic or functionality, even if the processor/s or controller/s are not specifically illustrated for simplicity. The controller or processor may be implemented in hardware, e.g., using one or more Application-Specific Integrated Circuits (ASICs) or Field-Programmable Gate Arrays (FPGAs), or may comprise a microprocessor that runs suitable software, or a combination of hardware and software elements.

The present invention may be described, merely for clarity, in terms of terminology specific to, or references to, particular programming languages, operating systems, browsers, system versions, individual products, protocols, and the like. It will be appreciated that this terminology or such reference/s is intended to convey general principles of operation clearly and briefly, by way of example, and is not intended to limit the scope of the invention solely to a particular programming language, operating system, browser, system version, or individual product or protocol. Nonetheless, the disclosure of the standard or other professional literature defining the programming language, operating system, browser, system version, or individual product or protocol in question, is incorporated by reference herein in its entirety.

Elements separately listed herein need not be distinct components, and alternatively may be the same structure. A statement that an element or feature may exist is intended to include (a) embodiments in which the element or feature exists; (b) embodiments in which the element or feature does not exist; and (c) embodiments in which the element or feature exist selectably e.g. a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate or route, or otherwise manipulate or process information as described herein and/or to perform functionalities described herein and/or to implement any engine, interface or other system illustrated or described herein. Any suitable computerized data storage e.g., computer memory may be used to store information received by or generated by the systems shown and described herein. Functionalities shown and described herein may be divided between a server computer and a plurality of client computers. These or any other computerized components shown and described herein may communicate between themselves via a suitable computer network.

The system shown and described herein may include user interface/s e.g. as described herein, which may, for example, include all or any subset of: an interactive voice response interface, automated response tool, speech-to-text transcription system, automated digital or electronic interface having interactive visual components, web portal, visual interface loaded as web page/s or screen/s from server/s via communication network/s to a web browser or other application downloaded onto a user's device, automated speech-to-text conversion tool, including a front-end interface portion thereof and back-end logic interacting therewith. Thus the term user interface, or “UI” as used herein, includes also the underlying logic which controls the data presented to the user e.g. by the system display, and receives and processes and/or provides to other modules herein, data entered by a user e.g. using her or his workstation/device.

### BRIEF DESCRIPTION OF THE DRAWINGS

Example embodiments are illustrated in the various drawings. Specifically:

FIG. 1 is a north finding system according to an embodiment of the present invention.

FIG. 2 is a high-level flow of a north finding method according to an embodiment of the present invention, which may be used in conjunction with the system of FIG. 1.

FIG. 3 is a detailed flow of the north finding method of FIG. 2, according to an embodiment of the present invention.

Methods and systems included in the scope of the present invention may include any subset or all of the functional blocks shown in the specifically illustrated implementations by way of example, in any suitable order e.g. as shown. Flows may include all or any subset of the illustrated operations, suitably ordered e.g., as shown. Tables herein may include all or any subset of the fields and/or records and/or cells and/or rows and/or columns described.

Computational, functional or logical components described and illustrated herein can be implemented in various forms, for example, as hardware circuits, such as but not limited to custom VLSI circuits or gate arrays or programmable hardware devices such as, but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines, and programs, and may originate from several computer files which typically operate synergistically.

Each functionality or method herein may be implemented in software (e.g. for execution on suitable processing hardware such as a microprocessor or digital signal processor), firmware, hardware (using any conventional hardware technology such as Integrated Circuit Technology), or any combination thereof.

Functionality or operations stipulated as being software-implemented may alternatively be wholly or fully implemented by an equivalent hardware or firmware module, and vice-versa. Firmware implementing functionality described herein, if provided, may be held in any suitable memory device, and a suitable processing unit (aka processor) may be configured for executing firmware code. Alternatively, certain embodiments described herein may be implemented partly or exclusively in hardware, in which case all or any subset of the variables, parameters, and computations described herein may be in hardware.

Any module or functionality described herein may comprise a suitably configured hardware component or circuitry. Alternatively or in addition, modules or functionality described herein may be performed by a general purpose computer, or more generally by a suitable microprocessor, configured in accordance with methods shown and described herein, or any suitable subset, in any suitable order, of the operations included in such methods, or in accordance with methods known in the art.

Any logical functionality described herein may be implemented as a real time application, if and as appropriate, and which may employ any suitable architectural option, such as but not limited to FPGA, ASIC or DSP, or any suitable combination thereof.

Any hardware component mentioned herein may in fact include either one or more hardware devices e.g., chips, which may be co-located, or remote from one another.

Any method described herein is intended to include within the scope of the embodiments of the present invention also any software or computer program performing all or any subset of the method's operations, including a mobile application, platform or operating system e.g., as stored in a medium, as well as combining the computer program with a hardware device to perform all or any subset of the operations of the method.

Data can be stored on one or more tangible or intangible computer readable media stored at one or more different locations, different network nodes, or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary, or off-line; which is of any type or level or amount or category of volatility, differentiation, mutability, accessibility, addressability, capacity, performance and energy use; and which is based on any suitable technologies such as semiconductor, magnetic, optical, paper, and others.

### DETAILED DESCRIPTION OF CERTAIN EMBODIMENTS

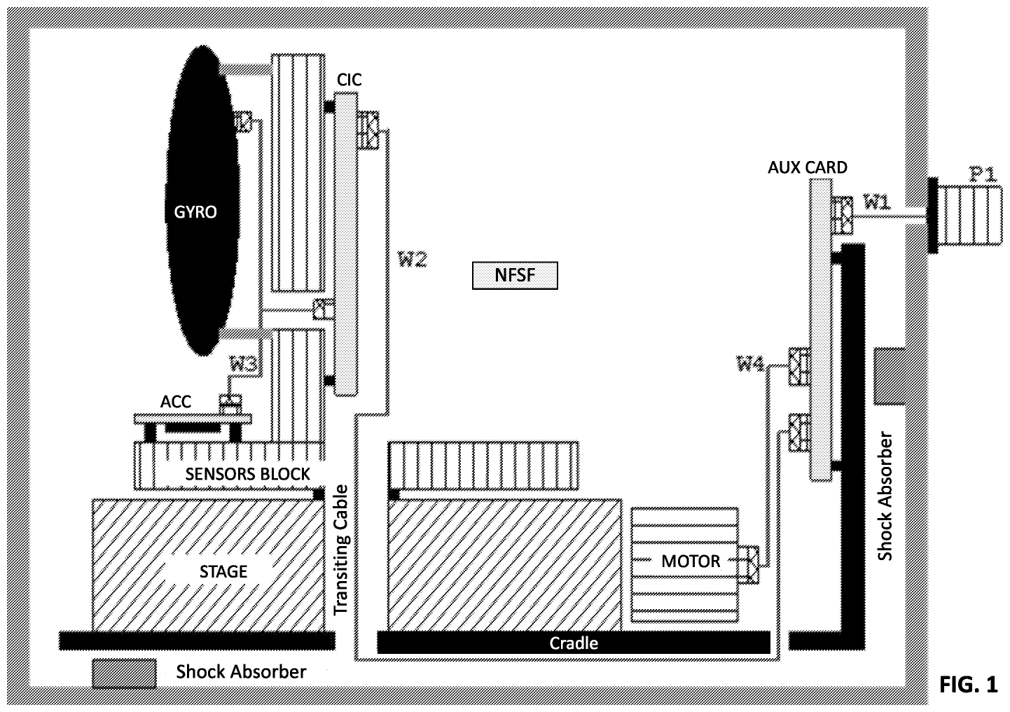

An example north finding system which finds the azimuth angle to the north is now described with reference to FIG. 1. The system may include all or any subset of a gyroscope, an accelerometer (aka ACC), a rotating stage aka indexing surface on which the gyroscope and/or accelerometer are mounted, and via which the gyroscope and/or accelerometer may be rotated to plural azimuthal positions about a main axis of the rotating stage, and a hardware processor (e.g. laptop, or General Industrial Controls Private Limited (GIC) electronic card), and suitable housing. The components may be interconnected by cables (such as illustrated cables W1-W4) in any suitable manner to serve functions described herein, e.g., as shown. A suitable connector e.g., P1 as shown, allows the system to communicate with other systems, typically including receiving a request to begin a north finding process and returning an output or result of this process.

Typically, the accelerometer is perpendicular to the gyroscope, and thus the gyroscope may measure angular velocity about a first axis (aka X-Axis) and the accelerometer may measure linear velocity about a second axis, perpendicular to the first axis (aka Y-Axis).

The north-finding system herein is typically operated on a static platform, including a moving platform which is currently stationary, such as a vehicle, or vessel, or other moving platform, just prior to embarking on a journey or mission.

The vehicle may, for example, be autonomous, or driverless, or self-driving. The term vehicle as used herein is intended to include vessels which travel through water. It is appreciated that if the platform e.g., vehicle or vessel is motorized, north finding may be performed, according to certain embodiments, when the vehicle's motor is on.

According to certain conditions a moving platform (say self driving vehicle or robot) uses an embodiment herein to find the north and then continues to navigate with a navigation system that keeps the north.

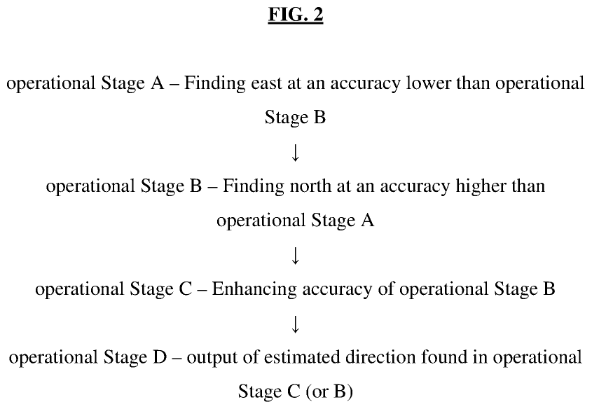

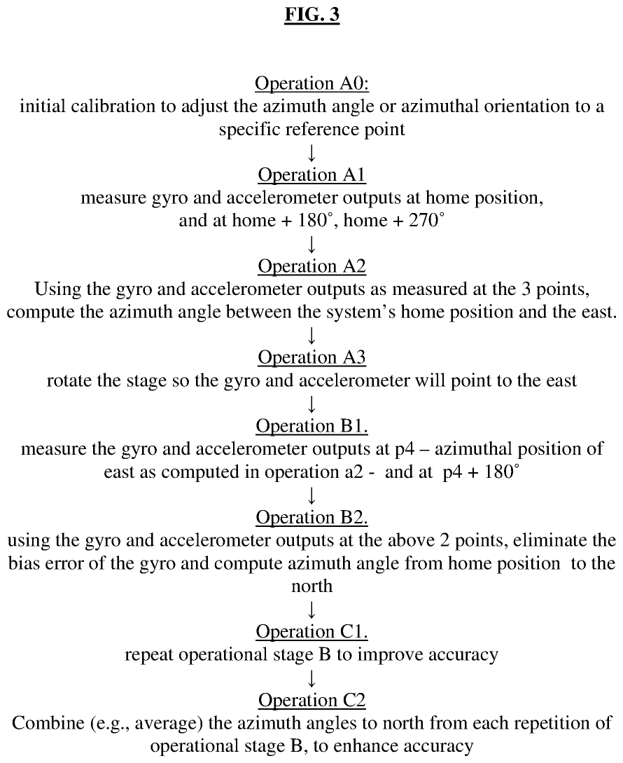

A north-finding process is now described with reference to FIGS. 2-3; all or any subset of the following operational stages and operations may be provided, in any suitable order e.g., as follows:

Operational Stage A—Finding the East at an Accuracy Lower than Stage B

Stage A may include all or any subset of the following operations, in any suitable order e.g., as shown:

### Operation A0:

According to certain embodiments, initial calibration is performed to adjust the azimuth angle or azimuthal orientation to a specific reference point (for example, if the system herein is mounted to a vehicle at a certain angle relative to the vehicle's heading, operation A0 determines or calibrates that angle, so that later, adjustments to the outputs of the method herein may be made, to yield results which are calibrated to the vehicle's heading. Any suitable method may be employed for operation A0, such as but not limited to boresight calibration.

Operation A0 need not be performed first; it may in fact be performed at the end of the process, e.g. after operation c2.

Operation A1 Measure gyro and accelerometer outputs at 3 points of measurement:

P1=a first position e.g., the system's reference azimuthal position or home position

P2, P3=other azimuthal positions, such as: P2=P1+180°, P3=P1+270°

### Operation A2

Using the gyro and accelerometer outputs as measured at the 3 points, compute the azimuth angle to the east e.g., the angle between the system's home (reference azimuthal) position and the east. The following formula may be employed:

$$ψ = {tan}^{- 1} [ \frac{2 \cdot ( {ω}_{3} - \frac{{ω}_{1} + {ω}_{2}}{2} + 15.04 \cdot sin lat \cdot sin φ \cdot sin θ )}{{ω}_{1} - {ω}_{2} + 30.08 \cdot sin lat \cdot sin θ} \cdot \frac{cos θ}{cos φ} + tan φ \cdot sin θ ]$$

$$α = π / 2 - ψ$$

Where:
α is the estimated angle between the system and the east
ω₁, ω₂, ω₃ are gyro measurements at P1-P3 respectively
φ, θ are roll and pitch angles measured by the accelerometer
lat is the latitude.

The accelerometer measures linear acceleration perpendicularly to the gyroscope, either by being mounted in a perpendicular axis or by moving it to a perpendicular position using the rotating stage, and thus the gyroscope may, (if its acceleration output is integrated), measure angular velocity about a first axis (say, X-Axis) and the accelerometer may measure linear velocity about a second axis, perpendicular to the first axis (e.g. Y-Axis).

It is appreciated that acceleration values measured by a gyroscope may be used to compute roll and pitch angles by comparing these values to gravity, because the accelerometer measures g·sin α where g is gravity acceleration and α is the angle to the horizontal plane. So roll angle of the gyro may be measured, and then, if the stage is rotated to 270 degrees, pitch angle may be measured.

ω₁, ω₂, ω₃ may be measured in the local gyro X axis, and this axis may be rotated with respect to the system X axis using a Euler rotation matrix.

### Operation A3

Rotate the stage so the gyro and accelerometer will point to the east. For example, if the angle computed in a2 was +15 degrees, rotate the gyro and accelerometer to −15 degrees relative to the starting point or home position.

The ending point for stage rotation may be +270° from the system's home position (whose azimuthal orientation is being sought).

Operational Stage B—Finding the North at an Accuracy Higher than Stage A

Stage B may include all or any subset of the following operations, in any suitable order e.g., as shown:

### Operation B1

Measure the gyro and accelerometer outputs at 2 more points:
p4=azimuthal position of east as was computed in operation a2
p5=p4+180°

### Operation B2.

Using the gyro and accelerometer outputs at the above 2 points, eliminate the bias error of the gyro and compute azimuth angle from home position to the north.

It is appreciated that a static gyro measurement may be represented as ω+ε where ω is the earth's rotation and ε is the gyro self-bias error. If the gyro is rotated 180°, the static gyro's measurement will then be −ω+ε such that measuring 2 points p4, p5 180° apart, and subtracting one from the other, allows the gyroscope's bias error ε to be eliminated (and/or summing both measurements allows the gyroscope's bias error ε to be estimated).

### Operational Stage C—Enhancing Direction-Finding Accuracy

Stage C may include all or any subset of the following operations, in any suitable order e.g., as shown:

### Operation C1

Repeat operational stage B a few more times (typically 1-3 times, in which case n, the number of repetitions, is 2-4). Typically, the gyro and accelerometer are positioned at P4, and measurements are taken, and then at P5, and measurements are taken, and then the gyro and accelerometer are again moved 180 degrees and positioned back at P4 for the next repetition, and so forth, the consideration being that & is not stable, thus measurements at each point P4 and its corresponding point 180° degrees away (P5) should be obtained at points in time which are as close together as possible.

### Operation C2

Combine (e.g., average) the accurate azimuth angle to the north obtained from each repetition of stage B, to yield an estimate for the accurate azimuth angle to the north of the Gyro when the gyro is located at (is rotated to) the “East” position. At this stage the gyro doesn't “look” to or face at the same direction as the system, having been rotated to East whereas the system, being static, does not move.

It is appreciated that repeating stage B n times (typically 1-3 times) and averaging the computations tends to increase the accuracy by a factor of Vn (relative to estimating the accurate azimuth angle to the north based on a single repetition of stage B.

### Operational Stage D—Output of Estimated Direction

Output the estimate generated in operation C2, as the system's azimuth to the north. This output may be provided to any suitable external system or platform, such as, for example, a vehicle, a portable system held by a human on the move, a satellite launcher, or any system operating in conditions (including underground conditions) where there is no satellite reception, such that GPS is not an option.

Each time an external system (e.g., a vehicle on which the system of the present invention is mounted) again requires an estimate of the system's azimuth to the north, stages A-D may be repeated. However, if it is known that the system has not moved since the last north finding attempt, stage A may be omitted.

If desired, operation A1 may be repeated plural e.g., K times, so as to point more accurately to the east, although the benefit of this may be insignificant. In this embodiment, typically, p1 in the k′th repetition of operation a1, would be the angle computed in the (k−1′th) repetition of operation a2.

References to “east” herein may be replaced, mutatis mutandis, with references to the opposite horizontal direction i.e. west. For operation A2, the following formula may be employed:

$${}^{′} a = 3 π / 2 - {tan}^{- 1} [ \frac{2 \cdot ( {ω}_{3} - \frac{{ω}_{1} + {ω}_{2}}{2} + 1.04 \cdot sin lat \cdot sin φ \cdot sin θ )}{{ω}_{1} - {ω}_{2} + 30.08 \cdot sin lat \cdot sin θ} \cdot \frac{cos θ}{cos φ} + tan φ \cdot sin θ ]$$

For final north finding:

After the system's azimuthal position has been established in the East, the accurate angle of the system's position (which would be 90° if the “East‘ azimuthal position were 100% accurate) may be computed, e.g., using:

$$γ = {cos}^{- 1} [ \frac{{ω}_{e} - {ω}_{w} + 30.08 \cdot sin lat sin {θ}_{e}}{30.08 \cdot cos lat cos {θ}_{e}} ]$$

Where:
ωₑ—the gyro measure at “East” position
ω_{w}—the gyro measure at “East” +180° position
lat—latitude of the system
θₑ—pitch of the system at “East” position

The accurate “East” angle may be computed plural times (e.g. by rotating the stage by 180° each time) and an average of the various repetitions may be computed and may be used to compute the Azimuth angle between the north and the system, e.g.:

$$A z = {tan}^{- 1} [ \frac{tan γ ( sin ψ cos θ + cos ψ sin φ sin θ ) - cos ψ cos φ}{tan γ cos ψ cos φ + sin ψ cos θ + cos ψ sin φ sin θ} ]$$

Where:
γ—average east angle of all repetitions
ψ—the initial azimuth to the north as computed during operation A2
θ—system pitch
φ—system roll

Conventional gyroscopes which measure true north, are afflicted by bias drift, which typically accumulates over time. A particular advantage of embodiments herein is that the system need not be repeatedly recalibrated as the gyroscope ages and its bias error E changes e.g., increases, because operation b2 eliminates the bias error.

It is appreciated that methods herein, being relatively fast, relatively insensitive to noise, relatively low-cost, and relatively accurate, are advantageous vis a vis, say, north finding processes which rely on a costly trio of static and accurate (e.g. RLG) gyroscopes.

Also, methods herein may employ a FOG gyroscope, unlike other methods which cannot do so, due to the low accuracy of FOG gyros.

Moreover, the methods herein need not demand a FOG with a closed-loop gyro (which has a lower error rate but is more costly), and can even, instead, employ an open-loop FOG gyro.

North-finding methods herein are also advantageous vis a vis time consuming methods (which, additionally, are normally inoperative in noisy environments e.g. in certain vehicles), which rotate a gyro e.g. a FOG gyro all around a circle) (360°, gathering data at very small azimuthal increments along the way (for example 2000 azimuthal positions distributed over the 360 degrees, to ensure accuracy), and estimating north by finding where the maximum gyro output value lies. These method's accuracy is limited by the number of increments, such that the method is either very slow, if many azimuthal positions are used (and not every use-case can tolerate such slowness), or inaccurate, if too few azimuthal positions are used (for example, if only 360 positions (every 1°) are used, then even if the gyro has 0 errors, accuracy is still only 2° since given that the n'th of the 360 points yields a maximum reading, the real maximum can be anywhere between point n−1 and point n+1. In addition, however, gyro error is not zero; to the contrary, the main source of gyro error which is bias drift, worsens with time, rendering such a slow method inaccurate to the point of impracticality. Furthermore, it is hard to find the maximum of a signal when the noise (e.g., ARW-Angular Random Walk error) is high, and even small-scale movement of the platform increases the signal noise significantly which again works against the practicality of this north-finding method in noisy environments.

Another advantage of embodiments herein, is suitability for noisy conditions (for conditions with a low signal to noise ratio). In contrast, methods based on finding north by identifying a maximum gyro output as a gyro rotates, are more sensitive to noise, because, in practice, it turns out that even given use of suitable filtering, a reading may be selected erroneously as north due to noise which artificially drives up value of the signal (actually signal-plus-noise) as read, and the actual north may fail to be selected.

It is appreciated that vehicles need not necessarily employ a dynamic north-finding technology, since vehicles may instead employ a static north-finding technology e.g., those shown and described herein, while the vehicle is at rest, even without turning off the motor.

It is appreciated that the methods herein are relatively fast; for example, the following durations may be allocated to complete each of operations A1-C2:
A1: ˜90 sec
A2: less than a second (computation only)
A3: up to ˜20 sec
B1: ˜50 sec
B2: less than a second (computation only)
C1: up to 150 sec (e.g. n*50=150 sec if n=3)
C2: less than a second (computation)
Total=up to ˜310 sec (˜5 minutes).

State of the art methods may easily require 10 minutes (for RLG north finders) or even 20 minutes (for conventional FOG-based north finders); it is appreciated that the time duration required varies, since there is a trade off between time and accuracy, such that a system may be operated for more or less time, depending on whether more accuracy or less accuracy and/or depending on whether more or less speed, are required for the use-case. For example, north-finding may be arbitrarily restricted to 10 minutes, for operational reasons, but due to the trade-off, the resulting accuracy may be very low. It is also appreciated that even a few minutes more or less can make a large difference in terms of bias drift.

A particular advantage of embodiments herein is that the system has low sensitivity to Scale Factor error Aka SF error, which pertains to changes, over time, in the transformation from voltage to angular velocity, which is another source of gyroscope error.

Due to the behavior of the cosine function, a gyroscope's lowest sensitivity to bias and SF (absolute scale factor) errors, both of which reduce accuracy of computation of an azimuth angle to the north, occur when the gyroscope is pointing at either west or east.

Because the accurate part of the process, e.g. stage B (operation/s b1 and/or b2) as described above, is performed while the gyroscope is in the east position (or, according to another embodiment, in the west position) in which ω=˜0, the SF is multiplied by only a very low, near-zero value (˜0), yielding a process with low sensitivity to SF error.

It is appreciated that “north-finding” as described herein is merely an example for finding a fixed reference azimuthal direction.

It is appreciated that the accelerometer need not, in fact, be perpendicular to the gyro although the above description assumes given that this embodiment tends to ease handling and computation. Alternatively, the accelerometer may be aligned with the gyro's axis and may be positioned at any angle thereto, e.g. if the rotating stage on which the accelerometer is mounted positions the accelerometer at some angle on the plane of the system other than 90 degrees. Typically, the accelerometer's axis is parallel to the system's main surface or main plane.

It is appreciated that terminology such as “mandatory”, “required”, “need” and “must” refer to implementation choices made within the context of a particular implementation or application described herewithin for clarity, and are not intended to be limiting, since, in an alternative implementation, the same elements might be defined as not mandatory and not required, or might even be eliminated altogether.

Components described herein as software may, alternatively, be implemented wholly or partly in hardware and/or firmware, if desired, using conventional techniques, and vice-versa. Each module or component or processor may be centralized in a single physical location or physical device or distributed over several physical locations or physical devices.

Included in the scope of the present disclosure, inter alia, are electromagnetic signals in accordance with the description herein. These may carry computer-readable instructions for performing any or all of the operations of any of the methods shown and described herein, in any suitable order, including simultaneous performance of suitable groups of operations as appropriate. Included in the scope of the present disclosure, inter alia, are machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order i.e. not necessarily as shown, including performing various operations in parallel or concurrently, rather than sequentially as shown; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform e.g. in software any operations shown and described herein; information storage devices or physical records, such as disks or hard drives, causing at least one computer or other device to be configured so as to carry out any or all of the operations of any of the methods shown and described herein, in any suitable order; at least one program pre-stored e.g. in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented e.g., by one or more processors. The invention shown and described herein may include (a) using a computerized method to identify a solution to any of the problems or for any of the objectives described herein, the solution optionally including at least one of a decision, an action, a product, a service, or any other information described herein, that impacts, in a positive manner, a problem or objectives described herein; and (b) outputting the solution.

The system may, if desired, be implemented as a network—e.g., web-based system employing software, computers, routers, and telecommunications equipment, as appropriate.

Any suitable deployment may be employed to provide functionalities e.g., software functionalities shown and described herein. For example, a server may store certain applications, for download to clients, which are executed at the client side, the server side serving only as a storehouse. Any or all functionalities, e.g., software functionalities shown and described herein, may be deployed in a cloud environment. Clients e.g., mobile communication devices such as smartphones, may be operatively associated with, but external to the cloud.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Any “if-then” logic described herein is intended to include embodiments in which a processor is programmed to repeatedly determine whether condition x, which is sometimes true and sometimes false, is currently true or false, and to perform y each time x is determined to be true, thereby to yield a processor which performs y at least once, typically on an “if and only if” basis e.g. triggered only by determinations that x is true, and never by determinations that x is false.

Any determination of a state or condition described herein, and/or other data generated herein, may be harnessed for any suitable technical effect. For example, the determination may be transmitted or fed to any suitable hardware, firmware or software module, which is known or which is described herein to have capabilities to perform a technical operation responsive to the state or condition. The technical operation may, for example, comprise changing the state or condition, or may more generally cause any outcome which is technically advantageous, given the state or condition or data, and/or may prevent at least one outcome which is disadvantageous, given the state or condition or data. Alternatively, or in addition, an alert may be provided to an appropriate human operator, or to an appropriate external system.

Features of the present invention, including operations, which are described in the context of separate embodiments, may also be provided in combination in a single embodiment. For example, a system embodiment is intended to include a corresponding process embodiment, and vice versa. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art and particularly, although not limited to those described in the Background section or in publications mentioned therein.

Conversely, features of the invention, including operations, which are described for brevity in the context of a single embodiment, or in a certain order, may be provided separately, or in any suitable sub-combination, including with features known in the art (particularly although not limited to those described in the Background section or in publications mentioned therein) or in a different order. “e.g.” is used herein in the sense of a specific example which is not intended to be limiting. Each method may comprise all or any subset of the operations illustrated or described, suitably ordered e.g. as illustrated or described herein.

Devices, apparatus, or systems shown coupled in any of the drawings, may in fact be integrated into a single platform in certain embodiments, or may be coupled via any appropriate wired or wireless coupling, such as but not limited to optical fiber, Ethernet, Wireless LAN, HomePNA, power line communication, cell phone, Smart Phone (e.g. iPhone), Tablet, Laptop, PDA, Blackberry GPRS, Satellite including GPS, or other mobile delivery. It is appreciated that in the description and drawings shown and described herein, functionalities described or illustrated as systems and sub-units thereof can also be provided as methods and operations therewithin, and functionalities described or illustrated as methods and operations therewithin can also be provided as systems and sub-units thereof. The scale used to illustrate various elements in the drawings is merely exemplary and/or appropriate for clarity of presentation, and is not intended to be limiting.

Any suitable communication may be employed between separate units herein e.g. wired data communication and/or in short-range radio communication with sensors such as cameras e.g. via Wifi, Bluetooth, or Zigbee.

It is appreciated that implementation via a cellular app as described herein is but an example, and, instead, embodiments of the present invention may be implemented, say, as a smartphone SDK, as a hardware component, as an STK application, or as suitable combinations of any of the above.

Any processing functionality illustrated (or described herein) may be executed by any device having a processor, such as but not limited to a mobile telephone, set-top-box, TV, remote desktop computer, game console, tablet, mobile e.g. laptop or other computer terminal, embedded remote unit, which may either be networked itself (may itself be a node in a conventional communication network, for e.g.) or may be conventionally tethered to a networked device (to a device which is a node in a conventional communication network, or is tethered directly or indirectly/ultimately to such a node).

Any operation or characteristic described herein may be performed by another actor outside the scope of the patent application and the description is intended to include apparatus, whether hardware, firmware, or software, which is configured to perform, enable, or facilitate that operation or to enable, facilitate, or provide that characteristic.

The terms processor or controller or module or logic as used herein are intended to include hardware such as computer microprocessors or hardware processors, which typically have digital memory and processing capacity, such as those available from, say Intel and Advanced Micro Devices (AMD). Any operation or functionality or computation or logic described herein may be implemented entirely or in any part on any suitable circuitry, including any such computer microprocessor/s as well as in firmware or in hardware or any combination thereof.

It is appreciated that elements illustrated in more than one drawings, and/or elements in the written description, may still be combined into a single embodiment, except if otherwise specifically clarified herewithin. Any of the systems shown and described herein may be used to implement or may be combined with, any of the operations or methods shown and described herein.

It is appreciated that any features, properties, logic, modules, blocks, operations or functionalities described herein, which are, for clarity, described in the context of separate embodiments, may also be provided in combination in a single embodiment, except where the specification or general knowledge specifically indicates that certain teachings are mutually contradictory and cannot be combined. Any of the systems shown and described herein may be used to implement or may be combined with, any of the operations or methods shown and described herein.

Conversely, any modules, blocks, operations or functionalities described herein, which are, for brevity, described in the context of a single embodiment, may also be provided separately or in any suitable sub-combination, including with features known in the art. Each element e.g., operation described herein, may have all characteristics and attributes described or illustrated herein or according to other embodiments, may have any subset of the characteristics or attributes described herein.

1-28. (canceled)

29. An improved method for finding a target direction, the method comprising:
computing a first azimuthal position which points to a horizontal direction;
moving a gyroscope and accelerometer from the first azimuthal position to a second, opposite azimuthal position 180 degrees away;
obtaining at least one gyroscope reading and at least one accelerometer reading in each of the two positions; and
using a hardware processor for computing an estimation of a required direction based on the at least one gyroscope reading and at least one accelerometer reading in the first azimuthal position and on the at least one gyroscope reading and at least one accelerometer reading in the second azimuthal position,
wherein outputs of said gyroscope and said accelerometer, measured at an azimuthal position of east and at a position 180° away from said azimuthal position of east, are used, plural times, to eliminate bias error of said gyroscope and to compute an azimuth angle from home position to north, thereby to yield plural azimuth angles to north;
and wherein said plural azimuth angles to north are combined to yield a single output having enhanced accuracy
wherein gyroscope and accelerometer outputs as measured at 3 points are used to compute an azimuth angle to the east to define p4, an estimated azimuthal position of east;
and wherein gyroscope and accelerometer outputs at two points are provided by measuring gyroscope and accelerometer outputs:
at said estimated azimuthal position of east (p4); and
at an azimuthal position 180 degrees away from p4,
and wherein said gyroscope and accelerometer outputs at 2 points are used at least once to eliminate bias error of the gyroscope and to compute at least one azimuth angle from home position to the north.

30. A method according to claim 29, wherein said at least one gyroscope reading and at least one accelerometer reading in each of the two positions comprises plural gyroscope readings and plural accelerometer readings in each of the two positions and wherein said computing an estimation of the required direction comprises:
estimating the required direction plural times, based on each of the plural gyroscope readings and plural accelerometer readings respectively, yielding plural estimations of the required direction; and
combining said plural estimations of the required direction to yield a single accurate estimation of the required direction.

31. A method according to claim 30, wherein said combining comprises averaging.

32. A method according to claim 29, wherein the gyroscope measures its own angular velocity relative to its own inertial position.

33. A system for finding a target direction, the system comprising:
a gyroscope,
an accelerometer perpendicular to the gyroscope;
a rotating stage on which the gyroscope and accelerometer are mounted, and
a hardware processor configured for computing
a first azimuthal orientation which points to a horizontal direction, based on readings taken when the gyroscope and accelerometer are in a first azimuthal position; and
an estimation of a required direction based on:
at least one gyroscope reading and at least one accelerometer reading in the first azimuthal position and
at least one gyroscope reading and at least one accelerometer reading in a second, opposite azimuthal position 180 degrees away from the first position,
wherein outputs of said gyroscope and said accelerometer, measured at an azimuthal position of east and at a position 180° away from said azimuthal position of east, are used, plural times, to eliminate bias error of said gyroscope and to compute an azimuth angle from home position to north, thereby to yield plural azimuth angles to north;
and wherein said plural azimuth angles to north are combined to yield a single output having enhanced accuracy
wherein gyroscope and accelerometer outputs as measured at 3 points are used by the system to compute an azimuth angle to the east to define p4, an estimated azimuthal position of east;
and wherein gyroscope and accelerometer outputs at two points are provided by measuring gyroscope and accelerometer outputs:
at said estimated azimuthal position of east (p4); and
at an azimuthal position 180 degrees away from p4,
and wherein said gyroscope and accelerometer outputs at 30 points are used by the system at least once to eliminate bias error of the gyroscope and to compute at least one azimuth angle from home position to the north.

34. A system according to claim 33, wherein said horizontal direction comprises east.

35. A system according to claim 33, wherein the required direction comprises north.

36. A system according to claim 33, wherein the target direction comprises north.

37. A system according to claim 33, wherein the required direction equals the target direction.

38. A method according to claim 29, wherein said horizontal direction comprises east.

39. A method according to claim 29, wherein the required direction comprises north.

40. A method according to claim 29, wherein the target direction comprises north.

41. A method according to claim 29, wherein the required direction equals the target direction.

42. A method according to claim 29, wherein an azimuthal distance between the target and required directions is known and wherein, accordingly, the target direction is computed from an estimation of the required direction.

43. A system according to claim 33, also comprising an output device configured to generate a physical output indication of at least one of the required and target directions, which is perceptible to a human.

44. A system according to claim 43, wherein the output device comprises a display screen.

45. A system according to claim 33, and also comprising an output device configured to generate an output indication, of at least one of the required direction and the target direction, which is machine-readable by an external system.

46. A system according to claim 45, wherein the output indication is provided to the external system via an API.

47. A system according to claim 33, wherein the gyroscope comprises a single gyroscope.

48. A system according to claim 33, wherein the gyroscope comprises a FOG gyroscope.
